(19) United States
(12) Patent Application Publication
(10) Pub. No.: US 2003/0033924 A1
(43) Pub. Date: Feb. 20, 2003

(54) Pick - can

(76) Inventor: Wayne Arthur Glover, Amity, OR (US)

Correspondence Address: Wayne A. Glover, P.O. Box 448, Amity, OR, 97101, US

(21) Appl. No.: 10/117,493

(22) Filed: Jun. 26, 2002

Related U.S. Application Data
(60) Provisional application No. 60/271,445, filed on Feb. 27, 2001.

(51) Int. Cl. G10D 3/16

(52) U.S. Cl. 84/320

(57) ABSTRACT

The pick-can is made using CNC machines and machine code programming along with sheet metal stamping to produce the slide plate and back plate. The pick-can is used to hold guitar picks so the player always has one when needed. The fact that the pick-can is crush proof makes it ideal for the guitar player who plays live in front of a large group of people.

The crush proof guitar pick holder consists of a housing block that can be machined out of any of the following materials metal, plastic, delron, nylon that will store the picks in a stack one on top of the other. It also consists of slide plate that the picks sit on pushed up by a coiled spring bringing one pick at a time to a point that they may slide out the slot in the housing block. All this is held together with a back plate that holds the slide plate, spring and picks in the housing block. This is fastened to the housing block by screws, press fit or glue when carried in the pocket or attached to the guitar by way of adhesive's or glue the guitar player always has a pick at there conveyance

The pick-can this is the name of my invention, it is made by machining aluminum, into the shape of the housing and stamping out the slide plate and back plate form sheet metal. After it is anodized in to one of seven colors it is assembled and sold to guitar players to use to hold guitar picks in. It can be attached to a guitar, a guitar strap, or a pocket using a clip similar to that used on a measuring tape.

### DESCRIPTION OF DRAWINGS

FIG. 1. This is a drawing of the housing block that holds the guitar picks stacked one on top of the other.

FIG. 2. This is a drawing of the slide plate the follows the picks as they slide up the housing block as they are removed to be used.

FIG. 3. This is a drawing of the back plate that holds the slide plate and guitar picks in the housing block.

FIG. 4. This is a picture of a group of pick-cans so you can see the completed product.

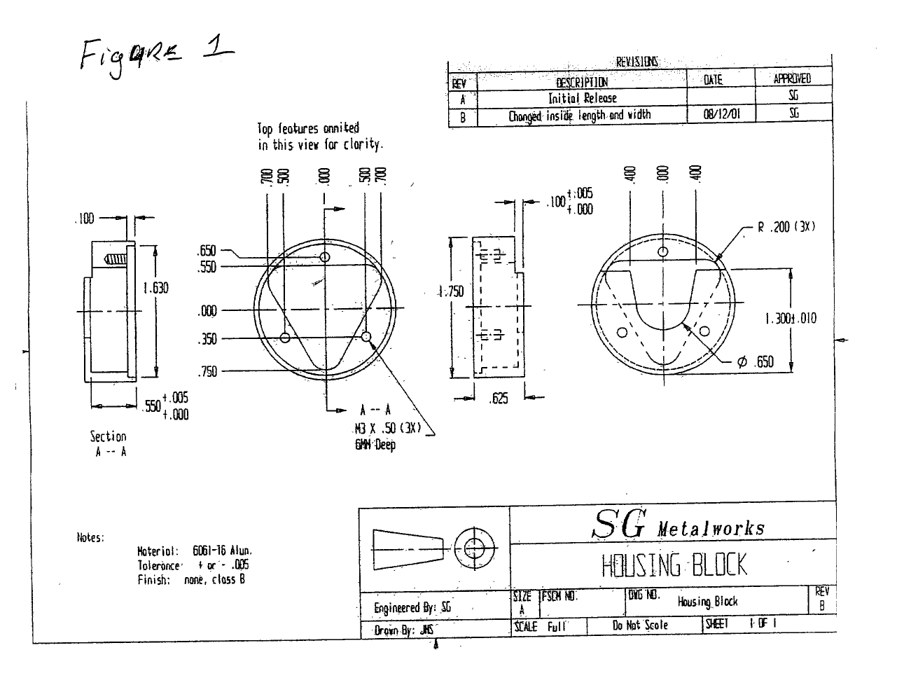

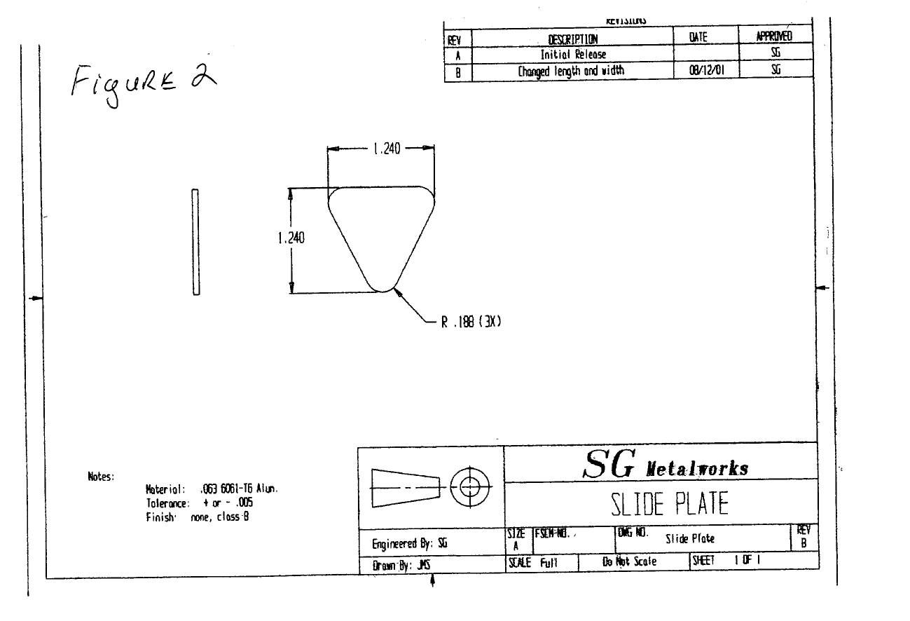

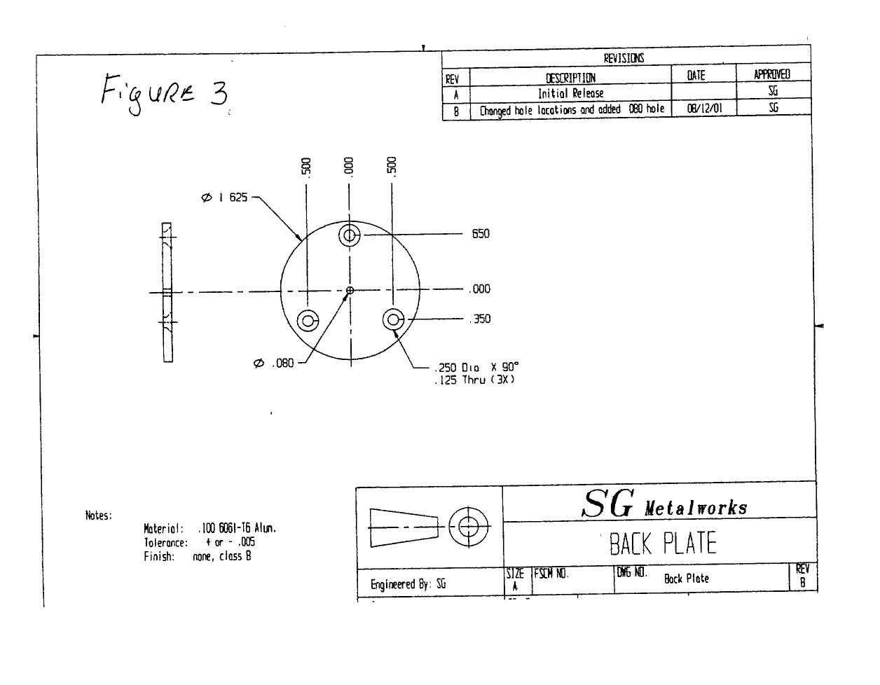

1. The pick-can holds up to fifteen guitar picks, It can be attached to a guitar, or a guitar players pocket, or to there guitar strap. It is made of machined aluminum and comes in seven colors.
